(19) United States
(12) Patent Application Publication
(10) Pub. No.: US 2015/0200804 A1
(43) Pub. Date: Jul. 16, 2015

(54) IN-VEHICLE APPARATUS FOR EFFICIENT REPROGRAMMING AND CONTROL METHOD THEREOF

(71) Applicant: Hyundai Motor Company, Seoul (KR)

(72) Inventors: Byoung Wook Lee, Seoul (KR); Ho Jin Jung, Seoul (KR)

(21) Appl. No.: 14/530,366

(22) Filed: Oct. 31, 2014

(30) Foreign Application Priority Data
Jan. 13, 2014 (KR) 10-2014-0003853

(51) Int. Cl. H04L 12/24; H04L 29/08

(52) U.S. Cl. CPC H04L 41/082; H04L 67/12

(57) ABSTRACT

A gateway which performs more efficient reprogramming of a plurality of controllers and a control method thereof are provided. The gateway includes a processor that authenticates a diagnostic apparatus and a firmware group that includes a plurality of different firmware corresponding to one function using the firmware group and authentication information regarding the firmware group received from the diagnostic apparatus when authentication of the diagnostic apparatus is completed. In addition, the plurality of different firmware included in the authenticated firmware group are transmitted to the plurality of controllers corresponding thereto, respectively.

### CROSS REFERENCE TO RELATED APPLICATION(S)

This application claims the benefit of Korean Patent Application No. 10-2014-0003853, filed on Jan. 13, 2014, which is hereby incorporated by reference as if fully set forth herein.

### BACKGROUND

1. Field of the Invention

The present invention relates to reprogramming of an in-vehicle controller, and more particularly, to a gateway which may perform more efficient reprogramming of a plurality of controllers and a control method thereof.

2. Discussion of the Related Art

Recently, many nodes of vehicle networks include electronic control units (ECUs), such as a body control module/electronic time and alarm control system (BCM/ETACS) configured to operate electronic components and chassis components, an anti-lock brake system electronic control unit (ABS ECU), an engine ECU, and an airbag ECU. These ECUs may perform a vehicle diagnostic service for safe and economic vehicle driving and thus prevent vehicle malfunction, and may also be configured to receive various types of vehicle information, such as vehicle driving record management and statistical information. Further, the ECUs may be configured to receive software upgrades, (i.e., reprogramming) such as change of specifications and upgrade of functions, as needed. This will be described with reference to FIG. 1.

FIG. 1 illustrates an exemplary process of performing reprogramming in a vehicle according to the related art. With reference to FIG. 1, a newest piece of firmware 110 is transmitted to a target controller subject to be upgraded among controllers 150 within a vehicle via a diagnostic apparatus 120, a diagnostic apparatus connector 130 of the vehicle, and a gateway 140. The target controller confirms the diagnostic apparatus 120, performs authentication of the piece of firmware 110, and performs the upgrade using the piece of firmware 160, authentication of which has been completed, based on a designated procedure.

However, control period connectivity increases due to an increase in the number of in-vehicle controllers and elaboration in techniques and thus, a situation in which a plurality of controllers need to be simultaneously upgraded in terms of a common technique/function may occur. For example, a function, such as smart cruise control (SCC), may be related to a plurality of controllers, (e.g., an engine controller, a brake controller, and a sensor controller). General firmware upgrade by a controller is performed in a manner in which a diagnostic apparatus and the controller reprogram firmware one to one. Such a procedure will be described in detail with reference to FIGS. 2A-2B.

FIGS. 2A-2B illustrate one example of a general process of performing a reprogramming procedure between a diagnostic apparatus and controllers within a vehicle. With reference to FIG. 2A, different firmware, each of which corresponds to each of three controllers, is prepared. In particular, a calculated piece of authentication information that corresponds to the piece of firmware of each controller is accompanied with the firmware. In other words, when three pieces of firmware are prepared, three pieces of authentication information are prepared.

When an upgrade of the controllers is simultaneously performed using the different firmware, the diagnostic apparatus transmits a reprogramming request to one of the controllers corresponding to one of the firmware (S210). Then, the corresponding controller is configured to transmit a seed value to the diagnostic apparatus (S220). The diagnostic apparatus is configured to calculate a key value in a predetermined manner (e.g., bitwise operation, encryption, etc.) using the seed value and return the calculated key value to the controller (S230). The controller is then configured to authenticate the diagnostic apparatus using a method in which the controller calculates a key value in a predetermined manner using the seed value transmitted to the diagnostic apparatus and compares the calculated key value with the key value received from the diagnostic apparatus (S240).

When confirmation of the diagnostic apparatus has been completed, the controller is configured to transmit a confirmation message to the diagnostic apparatus (S250) and the diagnostic apparatus may then be configured to perform transmission of the piece of firmware and authentication information (S260). The controller is configured to perform authentication of the firmware based on whether calculated authentication information and the received authentication information are the same (S270). For example, when a controller 1 is reprogrammed using firmware 1 of FIG. 2A, authentication information 1 is used.

Such a procedure, (i.e., the process from S210 to S270) is repeatedly performed twice with respect to firmware 2 and firmware 3. Consequently, when an update of different firmware related to one function is performed, although the same diagnostic apparatus is used, the above-described reprogramming process is repeated according to the respective firmware and thus, efficiency may be decreased.

### SUMMARY

Accordingly, the present invention provides an in-vehicle apparatus for more efficient reprogramming and a control method thereof that substantially obviate one or more problems due to limitations and disadvantages of the related art.

An object of the present invention is to provide an in-vehicle apparatus for more efficient reprogramming and a control method thereof which may perform reprogramming of a plurality of controllers related to one function more efficiently. Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a gateway performing reprogramming of a plurality of vehicle controllers corresponding to one function may include a diagnostic apparatus authentication unit configured to authenticate a diagnostic apparatus, a firmware authentication unit configured to perform authentication of a firmware group including a plurality of different firmware corresponding to one function using the firmware group and authentication information regarding the firmware group received from the diagnostic apparatus when authentication of the diagnostic apparatus is completed, and a firmware processing unit configured to transmit the plurality of different firmware included in the authenticated firmware group to the plurality of controllers corresponding thereto, respectively.

In another aspect of the present invention, a control method of a gateway performing reprogramming of a plurality of vehicle controllers corresponding to one function may include authenticating a diagnostic apparatus, receiving a firmware group including a plurality of different firmware corresponding to one function and authentication information regarding the firmware group from the diagnostic apparatus when authentication of the diagnostic apparatus is completed, performing authentication of the firmware group using the received firmware group and authentication information, and transmitting the plurality of different firmware included in the authenticated firmware group to the plurality of controllers corresponding thereto, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is an exemplary block diagram illustrating a general process of performing reprogramming within a vehicle according to the related art;

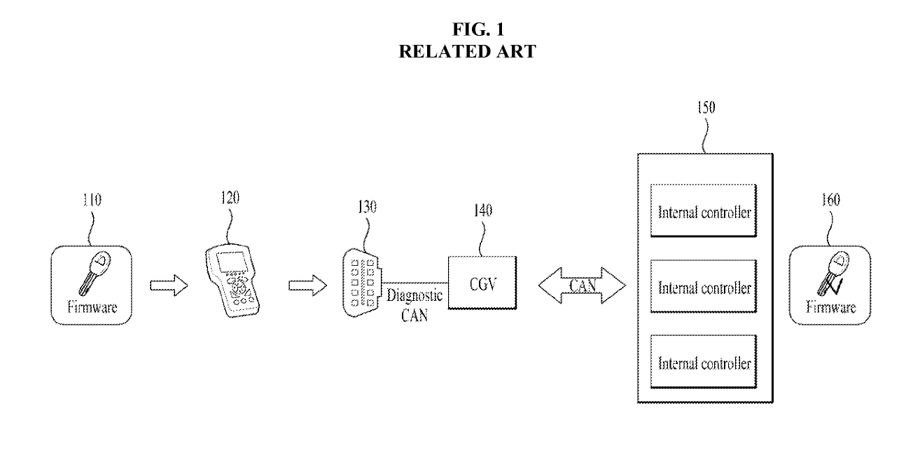

FIGS. 2A-2B are exemplary views illustrating a general process of performing a reprogramming procedure between a diagnostic apparatus and controllers within a vehicle according to the related art;

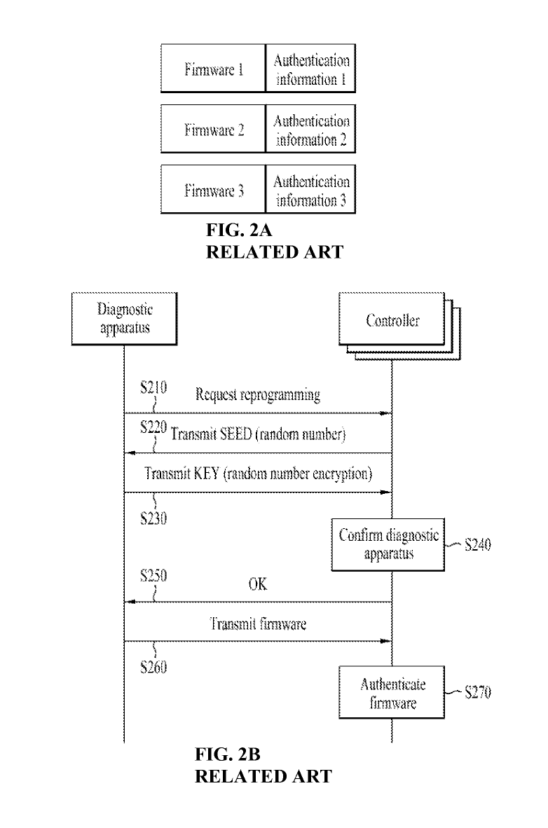

FIGS. 3A-3B are exemplary views illustrating a firmware structure and a process of performing a reprogramming procedure in accordance with one exemplary embodiment of the present invention;

FIG. 4 is an exemplary view illustrating a data structure of a functional group in accordance with one exemplary embodiment of the present invention; and

FIG. 5 is an exemplary block diagram illustrating a gateway structure in accordance with one exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present invention, examples of which are illustrated in the accompanying drawings.

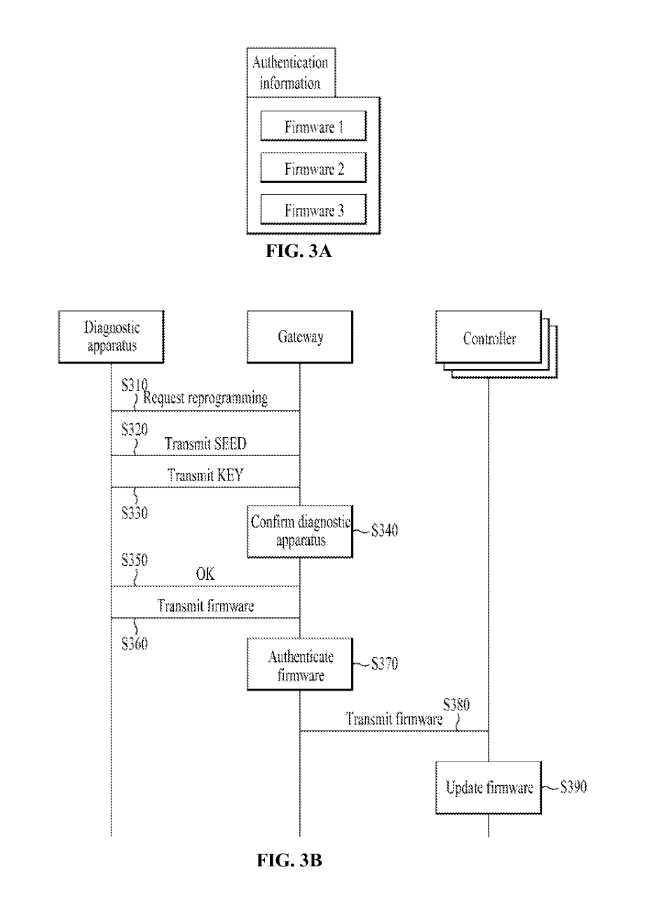

One exemplary embodiment of the present invention proposes that a plurality of different firmware form one functional group and common authentication of the corresponding functional group may be performed by a processor. For this purpose, this exemplary embodiment proposes that, instead of multiple authentication information corresponding to the plurality of different firmware, one type of authentication information is used with respect to the overall group, and authentication of a diagnostic apparatus and the firmware may be performed at a gateway. Correspondence between firmware and authentication information and a reprogramming procedure will be described with reference to FIGS. 3A-3B.

FIGS. 3A-3B are exemplary views illustrating a firmware structure and a process of performing a reprogramming procedure in accordance with one exemplary embodiment of the present invention. In FIG. 3, reprogramming in which three controllers are related to one function, i.e., one functional group includes three different firmware for three different controllers, will be assumed.

With reference to FIG. 3A, to perform reprogramming of one function, three different firmware may be prepared as one firmware group and one piece of authentication information may be prepared. In other words, authentication information may not be calculated with respect to each different firmware but may be calculated with respect to the firmware group. Therefore, the size of the authentication information may be reduced compared to when authentication information is generated with respect to each firmware. In such a reprogramming procedure using the firmware group, authentication of a diagnostic apparatus and the firmware group may be performed at a gateway other than the diagnostic apparatus, as exemplarily shown in FIG. 3B.

With reference to FIG. 3B, first, the diagnostic apparatus may be configured to transmit a reprogramming request for controllers that corresponds to the firmware group to the gateway (S310). Then, the gateway transmits a seed value to the diagnostic apparatus (S320). The diagnostic apparatus may be configured to calculate a key value in a predetermined manner (e.g., bitwise operation, encryption, etc.) using the seed value and return the calculated key value to the gateway (S330). The gateway may then be configured to authenticate the diagnostic apparatus using a method in which the gateway is configured to calculate a key value in a predetermined manner using the seed value transmitted to the diagnostic apparatus and compare the calculated key value with the key value received from the diagnostic apparatus (S340). When confirmation of the diagnostic apparatus has been completed, the gateway may be configured to transmit a confirmation message to the diagnostic apparatus (S350) and the diagnostic apparatus may be configured to transmit the firmware group and the authentication information of the overall firmware group (S360).

The gateway may further be configured to authenticate the overall firmware group based on whether authentication information calculated through the received firmware group and the received authentication information are the same (S370). In particular, as one example of a firmware authentication method, a secure flash technique may be used. In such a technique, to prevent update of modulated firmware, an electronic signature (e.g., symmetric key or asymmetric key) may be added to the firmware and whether firmware is modulated may be determined by verifying the electronic signature through an authentication medium (i.e., a gateway). A private key in a server and a public key that corresponds to the private key in a controller may be used as an electronic signature method. When the server encrypts a hash value of firmware using the private key and adds the encrypted hash value to the firmware, the authentication medium may be configured to authenticate the firmware by comparing a hashed value of the received firmware to a value acquired by decrypting the received encrypted hash value using the public key.

When authentication of the firmware group has been completed, the gateway may be configured to transmit respective different firmware included in the firmware group to the corresponding controllers (S380). Transmission of the individual piece of firmware may be repeated as many times as the number of different firmware, or transmission of the respective different firmware may be performed simultaneously. The respective controllers having received the corresponding firmware may be configured to update the corresponding firmware without a separate authentication process (S390).

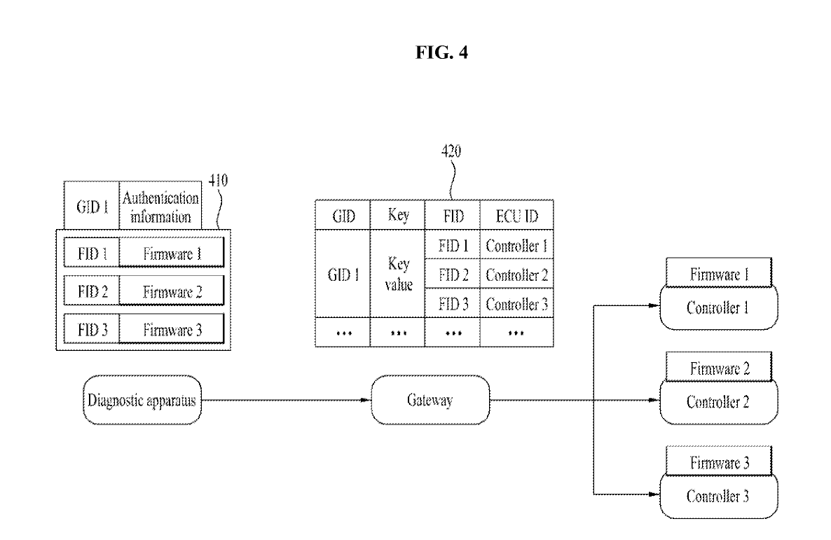

Consequently, since authentication of the diagnostic apparatus and the firmware group may be performed once using the above-described method, authentication of a plurality of different firmware may be completed in a reduced amount of time. Further, to perform a reprogramming procedure in the unit of a functional group through the gateway, information regarding the configuration of the functional group may be provided to the gateway in advance. For this purpose, a data structure will be described with reference to FIG. 4.

FIG. 4 is an exemplary view illustrating a data structure of a functional group in accordance with one exemplary embodiment of the present invention. With reference to FIG. 4, a firmware group 410 provided to the gateway through the diagnostic apparatus may be identified through one group identification (GID) and firmware IDs (FIDs) prepared in number corresponding to the number of different firmware included in the firmware group 410. In other words, since authentication of the functional group may be performed with respect to the entirety of the group, the GID to identify the functional group may be added to the firmware group 410. Further, to identify the respective different firmware, the FID may be added to each firmware. In summary, GIDs are inherent values to identify functional groups and FIDs are inherent values to identify the respective different firmware in the gateway.

A table 420 prepared in advance in the gateway may include a GID item, a key item, an FID item, and an ECU ID item. In addition, controller IDs (ECU IDs) are inherent values to identify the respective controllers and may match the FIDs one to one, and key values may match the GIDs. Using the above described table 420, when the diagnostic apparatus transmits a corresponding firmware group to the gateway, the gateway may be configured to recognize the corresponding firmware group through a GID and authenticate the corresponding firmware group using a key value that corresponds to the GID. When authentication succeeds, respective different firmware may be transmitted to respective corresponding controllers through FID and ECU ID pair information. When the respective controllers are connected via a separate communication line, the respective different firmware may be simultaneously transmitted and may thus increase efficiency in firmware transmission, thereby contributing to reduction of user wait time and labor costs.

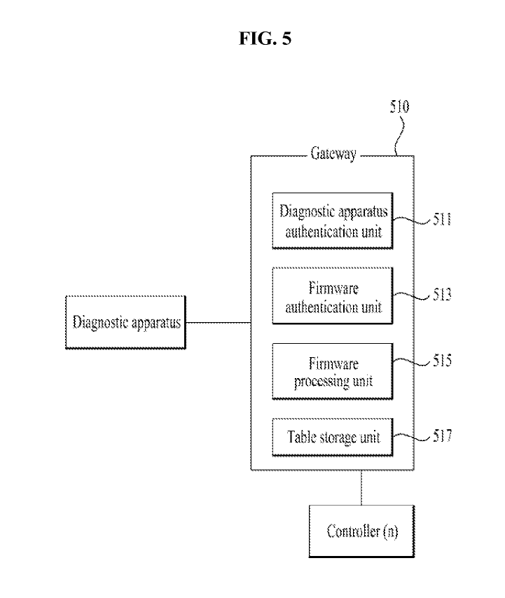

Moreover, a gateway structure which may perform the above-described reprogramming process will be described with reference to FIG. 5. In particular, FIG. 5 is an exemplary block diagram illustrating a gateway structure in accordance with one exemplary embodiment of the present invention.

With reference to FIG. 5, a gateway 510 in accordance with one exemplary embodiment of the present invention may be executed by a processor and may include a diagnostic apparatus authentication unit 511 configured to authenticate a diagnostic apparatus, a firmware authentication unit 513 configured to authenticate a firmware group, a firmware processing unit 515 configured to transmit respective different firmware included in the authenticated firmware group to corresponding controllers, and a table storage unit 517 configured to store the table 420 shown in FIG. 4. The table 420 stored in the table storage unit 517 may be referred to (e.g., accessed) by the firmware authentication unit 513 and the firmware processing unit 515. In particular, the firmware authentication unit 513 may be configured to authenticate the firmware group using a key value that corresponds to the GID of the firmware group. Further, the firmware processing unit 515 may be configured to transmit the respective different firmware to the corresponding controllers with reference to correspondence between FIDs and ECU IDs. Each of the elements forming the gateway 510 may be physically implemented through one module, or two or more of the elements may be implemented through one module. In other words, the respective elements do not need to be physically separated from one another and may be implemented by a software algorithm.

As apparent from the above description, a gateway in accordance with at least one exemplary embodiment of the present invention may be configured to perform reprogramming of a plurality of controllers related to one function. Particularly, since different firmware corresponding to the respective controllers related to one function may be authenticated by the gateway using one piece of authentication information, repetition of authentication may be prevented or omitted and the size of the authentication information may be reduced.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A gateway performing reprogramming of a plurality of vehicle controllers corresponding to one function, comprising:
a memory configured to store program instructions; and
a processor configured to execute the program instructions, the program instructions when executed configured to:
authenticate a diagnostic apparatus;
authenticate a firmware group that includes a plurality of different firmware corresponding to one function using the firmware group and authentication information regarding the firmware group authentication of the diagnostic apparatus is completed; and
transmit the plurality of different firmware included in the authenticated firmware group to the plurality of vehicle controllers corresponding thereto, respectively.

2. The gateway according to claim 1, wherein the program instructions when executed are further configured to:
store a table that includes group identifiers to identify firmware groups, key values that correspond to the group identifiers, firmware identifiers respectively corresponding to different firmware included in each of the firmware groups, and controller identifiers to identify vehicle controllers respectively corresponding to the pieces of firmware.

3. The gateway according to claim 2, wherein the program instructions when executed are configured to authenticate the firmware group using the key value that corresponds to the group identifier of the firmware group in the table.

4. The gateway according to claim 2, wherein the program instructions when executed are configured to transmit the respective different firmware to the corresponding controllers with reference to correspondence between the firmware identifiers and the controller identifiers in the table.

5. The gateway according to claim 1, wherein the authentication information is generated using the different firmware included in the firmware group.

6. A control method of a gateway performing reprogramming of a plurality of vehicle controllers corresponding to one function, comprising:
authenticating, by a processor, a diagnostic apparatus;
receiving, by the processor, a firmware group that includes a plurality of different firmware corresponding to one function and authentication information regarding the firmware group from the diagnostic apparatus when authentication of the diagnostic apparatus is completed;
authenticating, by the processor, of the firmware group using the received firmware group and authentication information; and
transmitting, by the processor, the plurality of different firmware included in the authenticated firmware group to the plurality of vehicle controllers corresponding thereto, respectively.

7. The control method according to claim 6, wherein the authentication of the firmware is performed using a group identifier to identify the firmware group and a key value that corresponds thereto in a predetermined table.

8. The control method according to claim 7, wherein the transmission of the plurality of different firmware to the plurality of vehicle controllers is performed with reference to correspondence between firmware identifiers corresponding to the plurality of different firmware included in the firmware group and controller identifiers to identify the plurality of vehicle controllers respectively corresponding to the plurality of different firmware in the predetermined table.

9. The control method according to claim 6, wherein the authentication information is generated using the different firmware included in the firmware group.

10. A non-transitory computer readable medium containing program instructions executed by a processor, the computer readable medium comprising:
program instructions that authenticate a diagnostic apparatus;
program instructions that authenticate a firmware group that includes a plurality of different firmware corresponding to one function using the firmware group and authentication information regarding the firmware group authentication of the diagnostic apparatus is completed; and
program instructions that transmit the plurality of different firmware included in the authenticated firmware group to the plurality of vehicle controllers corresponding thereto, respectively.

11. The non-transitory computer readable medium of claim 10, further comprising:
program instructions that store a table that includes group identifiers to identify firmware groups, key values that correspond to the group identifiers, firmware identifiers respectively corresponding to different firmware included in each of the firmware groups, and controller identifiers to identify vehicle controllers respectively corresponding to the pieces of firmware.

12. The non-transitory computer readable medium of claim 11, further comprising:
program instructions that authenticate the firmware group using the key value that corresponds to the group identifier of the firmware group in the table.

13. The non-transitory computer readable medium of claim 11, further comprising:
program instructions that transmit the respective different firmware to the corresponding controllers with reference to correspondence between the firmware identifiers and the controller identifiers in the table.

14. The non-transitory computer readable medium of claim 10, wherein the authentication information is generated using the different firmware included in the firmware group.
